(19) United States
(12) Patent Application Publication
(10) Pub. No.: US 2005/0138072 A1
(43) Pub. Date: Jun. 23, 2005

(54) Hierarchical groups

(75) Inventors: Joseph A. Russo, Westford, MA (US); Mustansir Banatwala, Hudson, NH (US); Miguel A. Estrada, Hollis, NH (US); Sami M. Shalabi, Arlington, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/744,301

(22) Filed: Dec. 22, 2003

(51) Int. Cl. G06F 17/00

(52) U.S. Cl. 707/104.1

(57) ABSTRACT

The present invention is a method, system and apparatus for hierarchically grouping a community of users within in a directory structure. for hierarchically grouping a community of users within a directory structure. A hierarchical grouping system can include a collaborative context having a community of subscribers, one or more roles assigned to the subscribers, and one or more tools and resources configured for access by the subscribers the access being limited by the roles. The system further can include a directly having entries associated with the subscribers. Notably, the directory can have a single hierarchical structure. Finally, the system can include a mapping between the directory and the roles in the collaborative context. Notably, the collaborative context can be a named collaborative space disposed in a portal environment and the directly can include an LDAP directory.

### BACKGROUND OF THE INVENTION

1. Statement of the Technical Field

The present invention relates to the field of collaborative computing and more particularly to hierarchically grouping a community of users within a directory structure.

2. Description of the Related Art

The rapid development of the Internet has led to advanced modes of communication and collaboration. Using the Internet as a backbone, individuals worldwide can converge in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include document libraries, instant messaging, chat rooms, and application sharing.

Conventional collaborative computing includes combinations of collaborative technologies in order to provide a means for members of a collaborative community to pool their strengths and experiences to achieve a common goal. For instance, a common goal can include an educational objective, the completion of a software development project or even the creation and use of a system to manage human resources. A collaborative computing community generally can be defined by (1) a particular context, i.e. the objective of the environment, (2) membership, i.e., the participants in the environment, (3) a set of roles for the members, and (4) resources and tools which can be accessed by the membership in furtherance of the objective of the environment. Roles are names given to the people in the environment which dictate access to the resources and tools within the environment as well as define the behavior of the community members.

Collaborative communities can be multi-hierarchical. That is different members of a community can fulfill multiple roles at different tiers of a hierarchy. In a single hierarchy, hierarchical nodes be described singly in terms of one attribute. Generally, single hierarchical structures include directory structures and the venerable n-tier tree. In a directory structure, typically entries are structured according to the alphabetical spelling of a name. In a collaborative community, however, members can be structured differently within the same community depending upon a particular role. For instance, in an educational community, members of the community can be hierarchically classified according teacher and student, as well as by social security number, as well as by gender, as well as by extracurricular affiliation. Notably, in some communities, different members can fulfill multiple roles, including student-teachers, player-coaches, and owner-operators.

Despite the inherent inflexibility of the database driven directory, the conventional directory remains the preferred technology of choice for configuring a scalable, secure, network accessible repository for user identifying information. Given the ubiquity of the directly, including the widespread usage of the lightweight directory access protocol (LDAP), it can be important to ensure the interoperability between the conventional directory structure and the membership of a collaborative community. Accordingly, it would be desirable to integrate the multi-hierarchical view of a collaborative community with the single hierarchy of a directory.

### SUMMARY OF THE INVENTION

The present invention addresses the deficiencies of the art in respect to collaborative computing and provides a novel and non-obvious method, system and apparatus for hierarchically grouping a community of users within a directory structure. In a preferred aspect of the present invention, a hierarchical grouping system can include a collaborative context having a community of subscribers, one or more roles assigned to the subscribers, and one or more tools and resources configured for access by the subscribers the access being limited by the roles. The system further can include a directory having entries associated with the subscribers. Notably, the directory can have a single hierarchical structure. Finally, the system can include a mapping between the directory and the roles in the collaborative context. Notably, the collaborative context can be a named collaborative space disposed in a portal environment and the directory can include an LDAP directory.

A hierarchical grouping method which has been configured in accordance with the system of the invention can include the steps of mapping attributes in a single hierarchically structured directory to individual roles in a multi-hierarchical collaborative context. A particular one of the roles can be selected and entries from the directory can be retrieved. Specifically, the retrieved entries can have mapped ones of the attributes which correspond to the particular one of the roles. In a preferred aspect of the present invention, the method further can include the step of addressing a sub-hierarchical grouping in the collaborative context based upon a listing of subscribers associated with the retrieved entries. In any case, preferably the selecting step further can include the step of limiting the selecting step to roles permitted to be viewed by a role assigned to a selecting one of the roles in the collaborative context.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a collaborative context configured for interoperation with a single hierarchy directory;

FIG. 2 is schematic illustration a system for hierarchically grouping a community of users within a directory structure; and,

FIGS. 3A and 3B, taken together, are a flow chart illustration a process for addressing individual roles with a multi-hierarchical grouping stored within a single hierarchical directory structure.

### DETAILED DESCRIPTION OF THE PREFERRED EMBODIMENTS

The present invention is a system, method and apparatus for hierarchically grouping a community of users in a collaborative context within in a single hierarchical directory structure. Specifically, the users within the community can be structured within the directory based upon a single hierarchical criteria, such as a name. Different attributes can be associated with each user entry in the directory structure and the different attribute types can be cataloged in a directory schema. Consequently, different roles within a collaborative community can be mapped to values for the different attribute type. When it is desired, then, to address a specific role within the community, the attribute for the role can be resolved with respect to the directory schema and the directory can be traversed to collect addressing information for each user having an attribute matching the role.

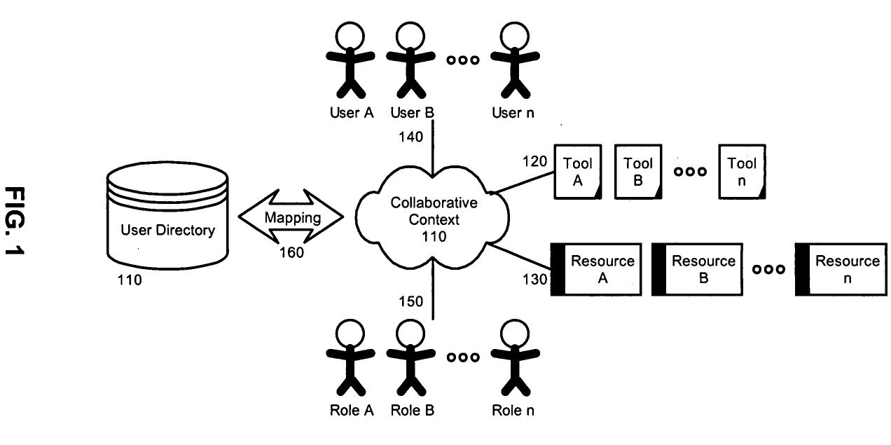

In further illustration of the general principle of the present invention, FIG. 1 is pictorial illustration of a collaborative context 110 configured for interoperation with a single hierarchy directory 170. The collaborative context 110 can include an arrangement of collaborators in a membership 140, roles 150 assigned to the collaborators in the membership 140, resources 130 which can be accessed and consumed by the collaborators in the membership 140, and logical components 120 referred to as tools which can be used by the collaborators in the membership 140 for the purpose of working towards the collaborative objective of the collaborative context 110.

The collaborators in the membership 140 can be computing users defined within the single hierarchy directory 170. The collaborators in the membership 140 can be associated with one or more roles 150. Each of the roles 150 can include permissions associated with collaborators in the membership 140 assigned to the role. The permissions can include which of the tools 120 can be accessed by the collaborators assigned to a specific one of the roles 150, and the extent to which the collaborators in the role can access the tools 120. The roles 150 also can limit which of the resources 130 can be accessed and consumed by the collaborators assigned to the roles 150.

The tools 120 in the collaborative context 110 can include logical processes, such as self-contained computing applications, servlets, or portlets, which can be formed from a single set of computing logic, or from a composition of multiple sets of computing logic. The tools 120 can include both conventional business logic, as well as other logic, for instance logic for managing the membership 140, the roles 150, and the resources 130. In any case, in a preferred aspect of the present invention, the collaborative context 110 can be implemented within a portal environment in which the tools 120 can be portlet representations dynamically aggregated within the portal environment. To that end, a template defining the collaborative context 110 can be processed in the portal aggregator to establish the specified arrangement of tools within the portal view.

According to the present invention, the single hierarchy directory 170 can include entries for each of the collaborators in the membership 140. Each of the entries can include a single identifier for the collaborator along with one or more attributes associated with the collaborator. Importantly, the entries in the directory 170 can be organized hierarchically according to the single identifier. That is to say, the organization of the entries in the directory 170 can be based only upon the single identifier. As the collaborators in the membership can be viewed multi-hierarchically according to assigned ones of the roles 150, however, a mapping 160 can be provided between the roles 150 and the entries in the directory 170. In this way, groups of users in the membership 140 can be addressed directly through the directory 170 despite the single hierarchical structure of the directory 170.

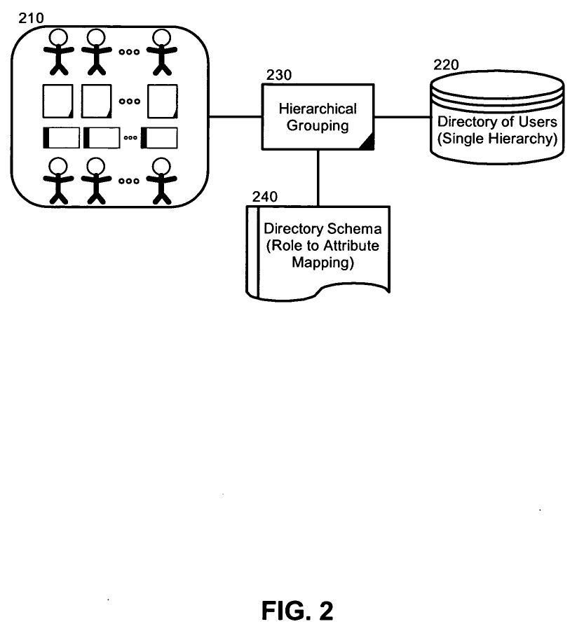

In more particular illustration, FIG. 2 is a schematic illustration a system for hierarchically grouping a community of users within a directory structure. The system can include a hierarchical grouping process 230 disposed between a single hierarchy directory 220 of subscribers and a collaborative context 210 in which the subscribers can fulfill one or more roles. In this regard, the subscribers can be viewed multi-hierarchically depending upon the particular view of a selected role. In view of the multi-hierarchical views available for the subscribers in the collaborative context 210, the hierarchical grouping process 230 can facilitate the referencing of sub-hierarchical groupings of subscribers in the collaborative context 210 through mapped access to the directory 220.

Specifically, when referencing the community of users in the collaborative context 210, the community can be referenced as a whole. More importantly, though, individual segments of the community also can be referenced to the exclusion of other segments of the community. These sub-hierarchical groupings of subscribers in the collaborative context can be selected by way of reference based upon the differentiating role assigned to the sub-hierarchical groupings. To reference the sub-hierarchical grouping of subscribers, the sub-hierarchical grouping can be referenced by way of the notation “role@community” where role is the differentiating role assigned to the sub-hierarchical grouping and community is the collaborative context 210 in which the sub-hierarchical grouping resides.

As each of the subscribers in the collaborative context 210 can be listed in the single hierarchical directory 220, the hierarchical grouping process can resolve the reference to the sub-hierarchical grouping by way of a directory schema 240 in which the role of the sub-hierarchical grouping can be mapped to attributes for the subscribers written in records in the directory 220. In this regard, each record in the directory 220 can include one or more attributes which can be mapped to particular roles in the collaborative context. Yet, as the subscribers can be organized strictly based upon a single criteria—typically the name of the subscriber—the attributes can play no role in the directory in structuring the hierarchical organization of the subscribers.

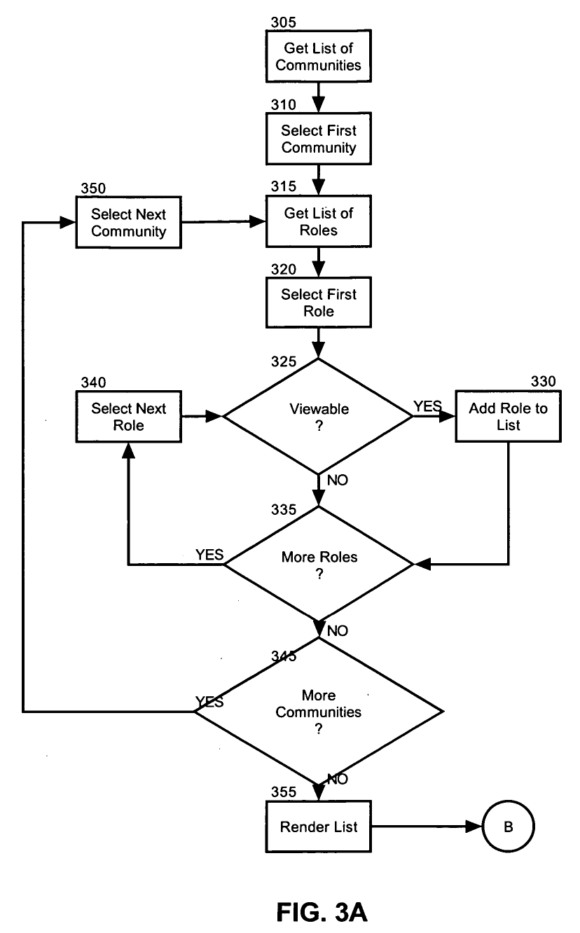

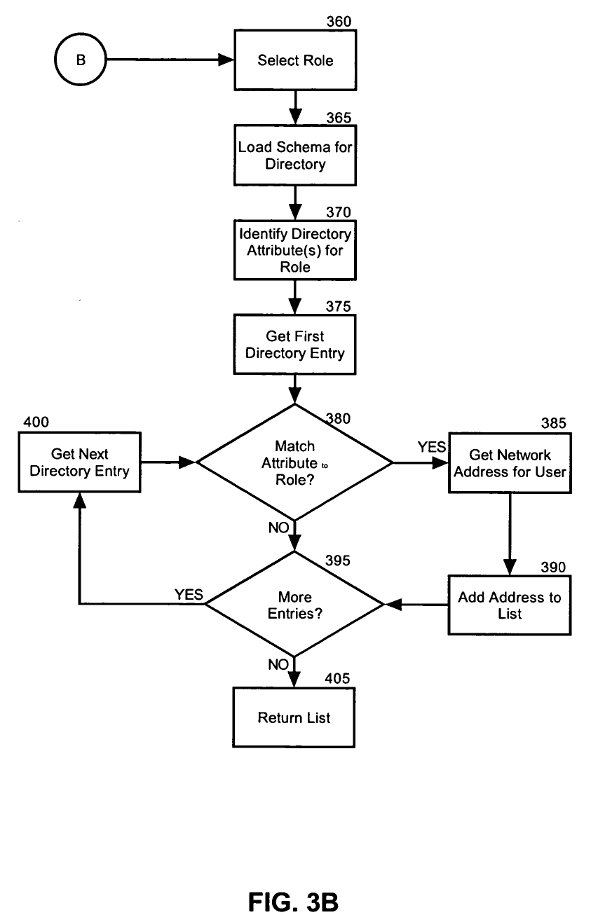

Nevertheless, in accordance with the present invention, the directory schema 240 describing the attributes can be used by the hierarchical grouping process 230 in order to resolve multiple hierarchical references into the directory 220 based upon different specified roles in the collaborative context 210. FIGS. 3A and 3B, taken together, are a flow chart providing yet further illustration of a process for addressing individual roles with a multi-hierarchical grouping stored within a single hierarchical directory structure. The process can be invoked when a subscriber having a particular role within one or more communities attempts to address a sub-hierarchical grouping of one or more of the communities.

Turning first to FIG. 3A, beginning in block 305 a list of communities to which the subscriber belongs can be retrieved. In block 310 a first community in the list can be retrieved and in block 315 a list of roles in the community can be retrieved. Importantly, only the viewing of roles in any one community by the subscriber can be limited by the characteristics of the role or roles associated with the subscriber. In this regard, the subscriber can only view those roles which are viewable by subscribers having role assigned to the subscriber. Accordingly, in block 320 a first role for the selected community can be retrieved. If, in decision block 325 the subscriber is permitted to view the role, in block 330 the role can be added to a list of addressable roles.

In either case, in decision block 335, if additional roles remain in the selected community, in block 340 a next role can be selected for analysis and the process can repeat in block 325 through block 340. Once all roles have been treated in the selected community, it can be determined in decision block 345 whether additional communities remain to be analyzed. If so, in block 350 the next community can be selected for analysis and the process can continue in blocks 315 through block 350. Once all communities have been analyzed, in block 355 a list of viewable roles can be rendered in a user interface for interaction with the subscriber.

Continuing through jump circle B to block 360 of FIG. 3B, the subscriber can select a role of interest. In block 365 a schema for the directory can be loaded for use by the hierarchical grouping process. In block 370, a directory attribute can be identified for the selected role of interest. Notably, one or more directory attributes can be identified for any one selected role of interest. In any case, in block 375 a first directory entry can be selected and in decision block 380 the attribute can be compared to the selected role to determine if the entry includes an attribute corresponding to the selected role. If so, the network address for the subscriber associated with the entry can be retrieved in block 385 and in block 390 the address can be added to a group address list.

In decision block 395, if more entries remain to be examined in the directory, in block 400 the next directory entry in the directory can be retrieved for processing. Subsequently, the process can continue in block 380 through block 400. In decision block 395, when no more entries remain to be examined, in block 405 the address list can be returned to the subscriber with which the subscriber can directly address the sub-hierarchical grouping.

Significantly, one skilled in the art will recognize that the hierarchical grouping process of the present invention permits a multi-hierarchical view of a directory structure despite the single hierarchy of the directory. As a result, popular and ubiquitous directory technologies can be seamlessly integrated in the collaborative environment to permit the addressing of multiple roles in the directory. The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A hierarchical grouping system comprising:
a collaborative context comprising a community of subscribers, a plurality of roles assigned to said subscribers, and a plurality of tools and resources configured for access by said subscribers said access being limited by said roles;
a directory comprising entries associated with said subscribers, said directory having a single hierarchical structure; and,
a mapping between said directory and said roles in said collaborative context.

2. The system of claim 1, wherein said collaborative context comprises a named collaborative space.

3. The system of claim 1, wherein said collaborative context is disposed in a portal environment.

4. The system of claim 1, wherein said directory comprises a lightweight directory access protocol (LDAP) directory.

5. The system of claim 1, wherein said mapping comprises a directory schema mapping attributes in each entry in said directory to said roles in said collaborative context.

6. A hierarchical grouping method comprising the steps of:
mapping attributes in a single hierarchically structured directory to individual roles in a multi-hierarchical collaborative context;
selecting a particular one of said roles; and,
retrieving entries from said directory having mapped ones of said attributes which correspond to said particular one of said roles.

7. The method of claim 6, further comprising the step of addressing a sub-hierarchical grouping in said collaborative context based upon a listing of subscribers associated with said retrieved entries.

8. The method of claim 6, wherein said selecting step further comprises the step of limiting said selecting step to roles permitted to be viewed by a role assigned to a selecting one of said roles in said collaborative context.

9. A machine readable storage having stored thereon a computer program for hierarchical grouping, the computer program comprising a routine set of instructions which when executed by a machine cause the machine to perform the steps of:
mapping attributes in a single hierarchically structured directory to individual roles in a multi-hierarchical collaborative context;
selecting a particular one of said roles; and,
retrieving entries from said directory having mapped ones of said attributes which correspond to said particular one of said roles.

10. The machine readable storage of claim 9, further comprising the step of addressing a sub-hierarchical grouping in said collaborative context based upon a listing of subscribers associated with said retrieved entries.

11. The machine readable of claim 9, wherein said selecting step further comprises the step of limiting said to step to roles permitted to be viewed by a role assigned to a selecting one of said in said collaborative context.

12. A hierarchical grouping method comprising the steps of:
mapping attributes in a single hierarchically structured directory to individual roles in a multi-hierarchical collaborative context;
coupling said mapping to said collaborative context; and,
configuring a hierarchical grouping process to access said mapping in order to resolve references to sub-hierarchical groupings of subscribers in said collaborative context to subscriber entries stored in said directory.
